(19) United States
(12) Patent Application Publication
(10) Pub. No.: US 2010/0229643 A1
(43) Pub. Date: Sep. 16, 2010

(54) MEASURING CONTAINER

(75) Inventor: Christine J. Lee, Seattle, WA (US)

Correspondence Address: BLACK LOWE & GRAHAM, PLLC, 701 FIFTH AVENUE, SUITE 4800, SEATTLE, WA, 98104, US

(73) Assignee: PROGRESSIVE INTERNATIONAL CORPORATION, Kent, WA (US)

(21) Appl. No.: 12/722,238

(22) Filed: Mar. 11, 2010

Related U.S. Application Data
(60) Provisional application No. 61/159,282, filed on Mar. 11, 2009.

(51) Int. Cl. G01F 19/00

(52) U.S. Cl. 73/426

(57) ABSTRACT

A measuring container includes first and second vessels each having a base and upwardly extending sidewalls defining an interior space. The first and second vessels are selectively connectable to one another at the base so that one may serve as a platform for the other, and are removable so that one may nest inside the other. Volumetric markings are incorporated onto an inclined sidewall of one or both vessels.

### PRIORITY CLAIM

This application claims the benefit of prior U.S. provisional application Ser. No. 61/159,282, filed Mar. 11, 2009 and incorporated by reference.

### FIELD OF THE INVENTION

This invention relates generally to measuring devices, particularly including devices that can be used for measuring small volumes.

### BACKGROUND OF THE INVENTION

Measuring small volumes can be a challenge, particularly for volumes that are larger than standard measuring spoons but smaller than typical measuring cups. The smaller measuring containers can be difficult to hold, measure, and pour. For certain volumes, the standard practice is to either repeatedly fill and pour multiple teaspoons or tablespoons, resulting in a lengthy and repetitive practice that may be inaccurate, or to fill a fraction of a much larger measuring cup, resulting in a measured volume that is likely to be inaccurate.

### SUMMARY OF THE INVENTION

The exemplary measuring device includes one or more vessels that are configured for measuring relatively small volumes. Though perhaps best suited for measuring small volumes as described in the preferred version, other embodiments of the invention may be used for larger volumes.

In the illustrated example, first and second vessels are shown, the first and second vessels being separable from one another. The first and second vessels each include a base and upwardly extending sidewalls defining an interior space. Though each of the vessels may have any desired volume within the interior spaces, in a preferred example the first vessel has a volume of about one ounce and the second vessel has a volume of about two ounces. The invention is ideally suited for such smaller volumes, which are too small to be accurately or conveniently measured in larger measuring cups, yet too large to be readily measured by measuring spoons.

In some examples of the invention, one or both of the vessels includes volumetric markings. Ideally, the vessels include a sidewall having at least one inclined surface, with the volumetric markings being incorporated onto the inclined sidewall so that they are visible and discernable when read from above.

As a further option, the vessels each include a magnet incorporated into the base, with the magnets being oriented such that they are attracted to one another when the outer surfaces of the bases are adjacent one another. In this fashion, the rim of one vessel may serve as a base for the other vessel, providing a more stable platform for measuring small volumes.

These and other examples of the invention will be described in further detail below.

### BRIEF DESCRIPTION OF THE DRAWINGS

Preferred and alternative examples of the present invention are described in detail below with reference to the following drawings:

FIG. 1 is a perspective view of a container having a first vessel and a second vessel, shown with the bases of each vessel attached to one another.

FIG. 2 is a side view of the vessels of FIG. 1, indicating internal magnets in phantom.

FIG. 3 is a side view of the vessels of FIG. 1, shown with a smaller vessel nested within a larger vessel.

FIG. 4 is a top view of a preferred vessel.

FIG. 5 is a perspective view of a preferred vessel, illustrated with the vessel oriented such that the rim is resting on a horizontal surface and the base is above the rim.

FIG. 6 is a perspective exploded view of two preferred vessels, including a first vessel above a second vessel.

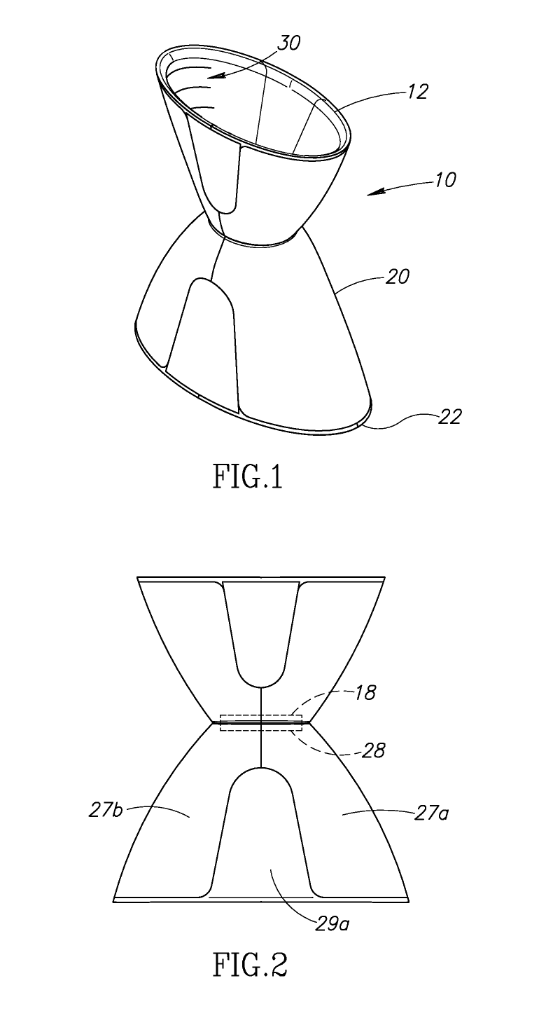

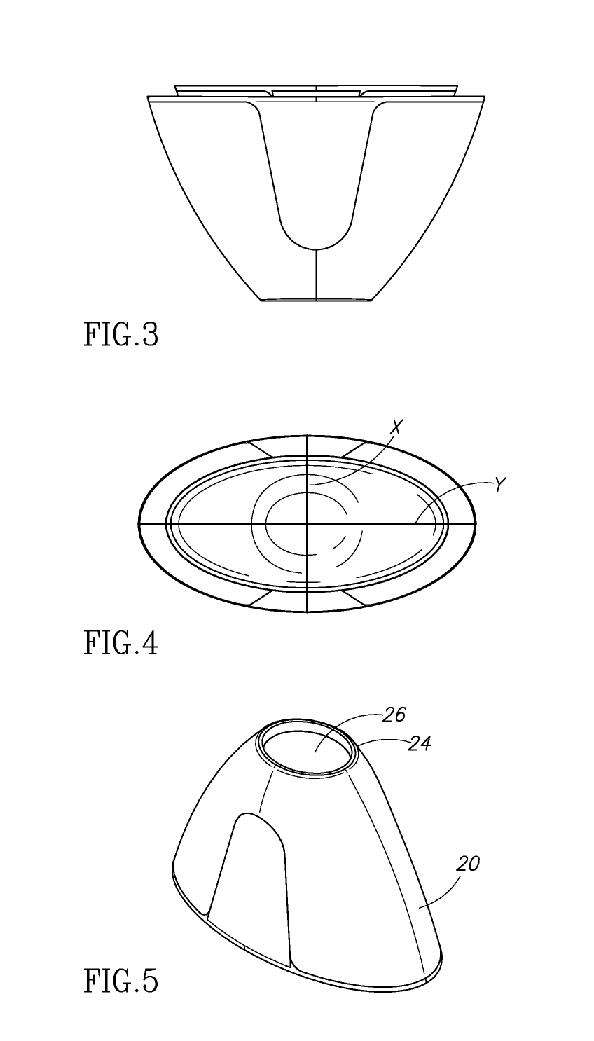

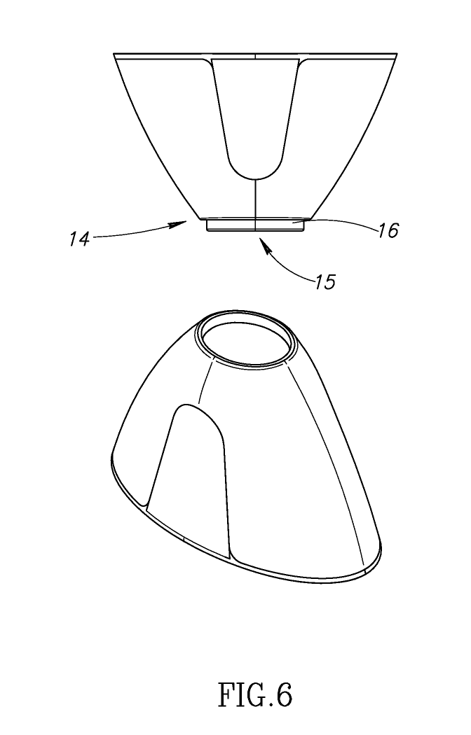

### DETAILED DESCRIPTION OF THE PREFERRED EMBODIMENT

The exemplary measuring device includes a first vessel 10 and a second vessel 20, the first and second vessels being selectively attachable to and separable from one another. The first and second vessels each include a base and upwardly extending sidewalls defining an interior space. Though each of the vessels may have any desired volume within the interior spaces, in a preferred example the first vessel has a volume of about one ounce and the second vessel has a volume of about two ounces. The invention is ideally suited for such smaller volumes, which are too small to be accurately or conveniently measured in larger measuring cups, yet too large to be readily measured by measuring spoons.

No particular shape is required of each of the vessels, though in a preferred version each of the vessels has a base that is generally planar and substantially circular. The base transitions to sidewalls that extend upwardly to a rim 12, 22, and in each case the rim is in the form of oval or an ellipse. The oval or elliptical shape of the rim allows for easier pouring from either side of the vessel. In addition, the oval shape at the rim defines a generally oval shape for the majority of the vessel as well. As a result, the vessel is taller for a given volume than would be the case if the vessel were configured with a circular rim and an overall shape that is closer to a regular cylinder.

The vessel is formed from a clear ABS plastic material in one example, though it may be manufactured from other materials, whether clear or opaque. In the version as shown, portions of the sidewalls of the ellipse are over-molded with a santoprene or other material. The generally elliptical rim of the vessel has a major axis y and a minor axis x. In the version as shown, the major axis is approximately twice as long as the minor axis. The santoprene material is over-molded along the opposing sidewalls at the ends 27a, 27b of the major axis but not covering portions of the opposing sidewalls at the ends (29a is visible; the opposing surface not being shown in FIG. 2) of the minor axis, thereby forming the vessel with portions of the sidewalls that are clear and portions that are opaque. The clear portions preferably extend substantially all the way to the base, and allow the user to see the volume of liquid or other measurable item contained within the vessel.

The sidewalls at each end of the major axis are inclined from the base to the rim because the major axis at the rim is greater than the diameter of the base. In the version as shown, the base is substantially circular, having a diameter that is somewhat less than the length of the minor axis. Along the inclined sidewalls, a series of volumetric markings 30 are provided to indicate the volume of the interior space of the vessel at various locations from the base to the rim. The volumetric markings are formed on the sidewalls such that they contrast with the over-molded material. In one example, the volumetric markings 30 are provided in a color that contrasts with a color of the over-molded sidewall material, enhancing the visibility of the volumetric markings. Depending on the sizes of the vessels, the volumetric markings may have units of fractions of a cup, fractions of an ounce, numbers of tablespoons or teaspoons, fractions of a liter, or other quantities.

In one version, the base of the first vessel and the base of the second vessel are each formed in a complementary fashion to allow one of the vessels to be inverted so that the bases of the vessels may be attached to one another. As illustrated, the first vessel 10 has a volume of one ounce while the second vessel 20 has a volume of 2 ounces. The base 14 of the first vessel forms a shallow upright cylinder, having a planar bottom surface 15 and upright sidewalls 16. The base 24 of the second vessel forms a generally cylindrical perimeter with a recessed region 26 that is sized and shaped to snugly receive the upright cylinder of the base 14 of the first vessel. Accordingly, the two vessels may be attached to one another by joining the bases together. In one version, the complementary sizing of the bases of the two vessels is such that the snug fit allows the two vessels to be frictionally held to one another.

It should be appreciated that the complementary nature of the bases may be reversed, such that the larger vessel has an upright cylinder at the base and the smaller vessel includes a recessed region for receiving the upright cylinder. Likewise, shapes other than an upright cylinder may be used to provide surfaces on the two bases that engage one another to allow the two vessels to attach to one another. In yet other versions, the bases of each of the two vessels may simply be flat at the bottom so that one may rest atop the other.

In another preferred version, magnets are used to facilitate the attachment of the first vessel to the second vessel. In one example, each vessel includes a small button or nib magnet 18, 28 embedded within the base. The magnets are arranged such that the north and south poles of the magnets will attract one another when the bases are attached to each other. Thus, in one of the two vessels the north pole faces upward, toward the rim, while the south pole faces downward, toward the base. In the other vessel the north pole faces downward, toward the base and the south pole faces upward, toward the rim. When the outer surfaces of the bases are placed adjacent one another, the north pole of one of the magnets will be facing the south pole of the other of the magnet, thereby attracting one another and helping to hold the bases of the vessels against one another. In this configuration the magnets will repel one another when the two vessels are placed in a nested position with one vessel inside the other.

In other versions, multiple magnets may be used. In one such version, two button or nib magnets may be incorporated into the base of each vessel, with one of the magnets arranged with its north pole oriented toward the rim and the other of the magnets arranged with its south pole oriented toward the rim. Preferably, the two magnets are arranged in line with one another, for example lying below opposite ends of either the major axis or the minor axis of the rim. In this configuration, when the bases of the two vessels are placed adjacent one another, the bases can be rotated until each of the two magnets from one vessel overlies each of the two magnets from the other vessel, with opposing poles placed adjacent one another to urge the bases of the vessels toward one another. In the nesting position, the vessels can likewise be arranged such that the poles of the magnet will attract one another, urging the vessels toward one another in the nested position.

In the version as shown, the first vessel is preferably sized and shaped such that the exterior sidewalls of the first vessel fit within the interior sidewalls of the second vessel. In addition, the height of the first vessel is approximately equal to the height of the interior portion of the second vessel, defined from the inner surface of the base to the rim. This allows the first vessel to be received within the second vessel in a nested configuration for convenient storage, with the rim of the first vessel being at about the same height as the rim of the second vessel.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

The embodiments of the invention in which an exclusive property or privilege is claimed are defined as follows:

1. A measuring container, comprising:
a first vessel having a first base and a first rim, with upwardly extending sidewalls extending from the first base to the first rim to define a first interior space, the first base having an inner surface within the first interior space and an outer surface external to the first interior space;
a second vessel having a second base and a second rim, with upwardly extending sidewalls extending from the second base to the second rim to define a second interior space, the second base having an inner surface within the second interior space and an outer surface external to the second interior space;
the outer surface of the first base and the outer surface of the second base each being configured to mate with one another whereby the outer surface of the first base is removably attached to the outer surface of the second base.

2. The measuring container of claim 1, wherein the outer surface of the first base of the first vessel further comprises a projection and the outer surface of the second base of the second vessel further comprises a cavity, the cavity being sized and arranged to snugly receive the projection to frictionally and removably secure the first vessel to the second vessel.

3. The measuring container of claim 2, wherein the projection is substantially in the shape of an upright regular cylinder.

4. The measuring container of claim 1, further comprising:
a first magnet secured to the first base; and
a second magnet secured to the second base;
wherein the first magnet and the second magnet are oriented such that they are attracted to one another when the outer surface of the first base is adjacent to and facing the outer surface of the second base.

5. The measuring container of claim 4, wherein the outer surface of the first base is substantially planar and the outer surface of the second base is substantially planar.

6. The measuring container of claim 4, wherein the first magnet is embedded within the first base between the inner surface and the outer surface of the first base, and the second magnet is embedded within the second base between the inner surface and the outer surface of the second base.

7. The measuring container of claim 4, wherein the outer surface of the first base further comprises a projection and the outer surface of the second base further comprises a cavity, the cavity being sized and arranged to snugly receive the projection to frictionally and removably secure the first vessel to the second vessel.

8. The measuring container of claim 7, wherein the first rim is elliptical in shape and the second rim is elliptical in shape.

9. The measuring container of claim 8, wherein the first rim comprises a major axis and an orthogonal minor axis, the major axis being approximately twice as long as the minor axis.

10. The measuring container of claim 9, wherein the first base is substantially circular, the first base having a diameter that is approximately equal to the minor axis.

11. The measuring container of claim 10, wherein the first vessel is nestable within the second vessel, the second interior space being approximately twice as large as the first interior space, whereby when the first vessel is nested within the second vessel the first rim and the second rim are each at approximately the same height above the second base.

12. The measuring container of claim 11, wherein the sidewalls of the first container further incline upwardly from the first base to the first rim and include volumetric markings corresponding to defined volumes within the first interior space.

13. The measuring container of claim 12, wherein the sidewalls of the first vessel are configured from a clear material adjacent the minor axis and include an opaque material adjacent the major axis and underlying the volumetric markings.

14. A measuring container, comprising:
a first vessel having a first base and a first rim, with upwardly extending sidewalls extending from the first base to the first rim to define a first interior space, the first base having an inner surface within the first interior space and an outer surface external to the first interior space;
a second vessel having a second base and a second rim, with upwardly extending sidewalls extending from the second base to the second rim to define a second interior space, the second base having an inner surface within the second interior space and an outer surface external to the second interior space;
a first magnet secured to the first base; and
a second magnet secured to the second base;
wherein the first magnet and the second magnet are oriented such that they are attracted to one another when the outer surface of the first base is adjacent to and facing the outer surface of the second base.

15. The measuring container of claim 14, wherein the first magnet is embedded within the first base between the inner surface and the outer surface of the first base, and the second magnet is embedded within the second base between the inner surface and the outer surface of the second base.

16. The measuring container of claim 14, wherein the outer surface of the first base further comprises a projection and the outer surface of the second base further comprises a cavity, the cavity being sized and arranged to snugly receive the projection to frictionally and removably secure the first vessel to the second vessel.
